(19) United States
(12) Patent Application Publication
(10) Pub. No.: US 2012/0128849 A1
(43) Pub. Date: May 24, 2012

(54) PROCESS FOR DEFROSTING OF FROZEN CRUSHED MEAT

(76) Inventor: Anders Oestergaard, Hoeng (DK)

(21) Appl. No.: 13/321,235

(22) PCT Filed: May 19, 2010
(86) PCT No.: PCT/EP10/03085

§ 371 Date: Feb. 10, 2012

(30) Foreign Application Priority Data
May 20, 2009 (EP) 09006825.5

(51) Int. Cl. A23B 4/07; B01F 13/06; B02C 11/08

(52) U.S. Cl. 426/511; 241/23; 366/139

(57) ABSTRACT

The present invention relates to a process and an apparatus for defrosting of frozen crushed meat.

The present invention relates to a process and an apparatus for defrosting of frozen crushed meat.

In order to produce products, like nuggets or the like, from crushed meat, in the past, bocks of meat were defrosted, for example in a tumbler or defrosting-room, and/or under the influence of microwave-radiation. Afterwards, the defrosted meat was crushed and then cooled again, for example with liquid nitrogen or Carbon dioxide, and then formed, coated and/or cooked. Afterwards the resulting product was frozen. The defrosting process, however, has the disadvantage, that it takes very long, and is very energy-consuming.

It was therefore the problem of the present invention, to provide a defrosting process that is less time- and energy-consuming.

This problem is solved by a process for defrosting of frozen meat in a mixer, characterized by the following steps:

a. crushing the frozen meat

b. loading the crushed meat into a mixer,

c. mixing the crushed meat,

d. applying at least partial vacuum to the mixer and

e. adding steam to the mixer,
whereas steps c-e are at least partially in parallel.

According to the present invention, the frozen meat, for example in form of a block or in form of chunks is crushed. This can be, for example, carried out in a grinder or in a cutter. Meat according to the present invention is any meat known to a person skilled in the art, for example meat from a pig, a cow, a lamb and/or poultry. Meat according to the present invention can comprise skin and/or bones, which are preferably removed (deboned) after defrosting. After the crushing of the meat, the longest extension of each meat part is preferably ≦80 mm, more preferably ≦60 mm, even more preferably ≦40 mm, even more preferably ≦30, even more preferably ≦20 and most preferably ≦8 mm, however,

Preferably, ≧3 mm. The meat-parts need not have uniform size, but can have a mixture of different sizes.

After the frozen meat has been crushed, the frozen crushed meat is loaded into a mixer. This mixer comprises at least one, preferably two or more means, for example axle(s) with paddles, to mix the crushed meat in the mixer.

In a next step, this crushed, frozen meat is subjected to at least partial vacuum. Preferably, the vacuum in the mixer is established around 20-150 mbar, more preferably 50-100 mbar. Preferably, the vacuum is drawn by a vacuum-pump, which is switched on and off, based on two set vacuum-levels inside the mixer.

After partial vacuum has been established in the mixer, steam is added to the mixer. When the steam comes into contact with the frozen crushed meat, it condenses immediately. Preferably, the steam temperature in the mixer does not exceed 60° C., preferably 50° C., more preferably 40° C. Preferably, the steam is applied to the mixer intermittently. When the steam addition is stopped, preferably vacuum is drawn.

Preferably, the steam is applied, most preferably injected, to the mixer from the bottom.

Preferably, the crushed meat is not defrosted entirely, but only partially. More preferably, the temperature of the crushed meat does not exceed 0° C., more preferably −1° C., most preferably −2° C. during the defrosting, anywhere in the mixture.

In a preferred embodiment, the remaining crystallization of the water in the meat and/or on the surface of the is 20-40, preferably 20-30 weight-%; i.e. this water amount of water is in an at least partially solid state. This preferred embodiment of the invention as the advantage, that the formability of the crushed meat is improved.

Preferably, the defrosting process is controlled by temperature- and/or power-uptake-measurements of the mixing-means. In case the meat temperature has risen to a certain value and/or the power-uptake has decreased to a certain value (Watt), the defrosting process is terminated.

After the defrosting process, the added condensate during defrosting is between preferably 4 and 9, preferably 5 and 8 weight-% of the initial weight of the meat. This condensate can be used as a brine and is preferably bound chemically and or physically in the crushed meat.

In a preferred embodiment of the present invention, spices, like salt, pepper and/or herbs, are added during mixing, more preferably after the defrosting is terminated. Preferably, the temperature of the crushed meat is reduced by the addition of salt as a spice.

After the defrosting process is terminated, the defrosted crushed meat is taken out of the mixer, formed, deboned, further crushed, coated and/or cooked and then preferably, finally frozen.

The inventive process has the advantage that the defrosting of the meat only takes minutes. The meat can be taken directly from the freezer and subjected to the inventive process. Cooling of the crushed meat after mixing and prior to forming can be avoided. The meat is not damaged, especially not cooked or precooked during the addition of steam. The inventive process is much more energy efficient than conventional processes.

The inventive process is one more time explained by the following summary:
1. Frozen blocks of meat, for example poultry, is taken from a freezer, preferably tempered until its plastic coating can be removed.
2. The meat is crushed, preferably with a grinder.
3. The crushed meat is loaded into a mixer and the defrosting program is run under partial vacuum and the addition of steam.
4. Defrosting is continued preferably until 75% of the product water (25% crystallization) is defrosted.
5. Preferably salt is added, which together with the condensed steam form a brine, which more preferably is bound in the meat.
6. Preferably addition of spices and/or extenders.
7. Preferably, mix, more preferably under partial vacuum, until texture and/or viscosity is suitable for forming.
8. Preferably forming, coating, cooking and/or freezing.

The inventive process is suitable for defrosting meat and/or meat comprising bones like carcasses, which are deboned after they have been defrosted according to the inventive process. The meat defrosted according to the present invention, can be also used to produce the filling of sausages. In this case, the meat is preferably ground after the defrosting process and then filled into a sausage-casing.

Advantages of the inventive process:

1) Simple logistics due to processing the meat directly from the freezer.

2) Substantial energy savings by not defrosting completely

3) Eliminate the cost of cooling gas.

4) Space saving

5) Mixing-time reduced by approximately 50% compared with gas cooling. Thus more capacity is available or less or smaller equipment is needed.

Another subject matter of the present invention is a mixer with a bowl and at least one mixing means, for example paddles, which comprises means to apply steam and at least a partial vacuum to the inside of the mixer.

Preferably, such a mixer comprises a bowl and a lid. In the bowl, one or more rotary driven axle(s) are arranged, which comprise mixing means such as paddles, which mix the ground frozen meat. The axle(s) can preferably be rotated in two different directions. The mixer is preferably made of stainless steel.

According to the present invention, the mixer comprises means to apply at least partial vacuum to the inside of the bowl. Such means are for example openings, which can be, for example, connected to a vacuum-pump. More preferably, the mixer comprises a pressure sensor, which measures the pressure inside the mixer. This pressure sensor is preferably used to control the degree of vacuum inside the mixer. The vacuum is preferably drawn in the upper part of the bowl.

Preferably the mixer comprises nozzles at the bottom, which inject steam into the inside of the mixer.

Another embodiment of the present invention, is the use of a mixer for defrosting of ground meat and/or carcasses in the presence of vacuum and steam. The above said also applies to this embodiment of the invention.

The invention is now explained with the following examples:

### EXAMPLE I

Frozen blocks of chicken at −15 C.

| | | | |
|---|---|---|---|
| Breast fillet | 150 kg | Ground 40 mm | −7.5 C. |
| Thigh meat | 150 kg | Ground 40 mm | −7.5 C. |
| Chicken skin | 30 kg | Chopped fine in bowl chopper | −0.8 C. |

The frozen meats were ground with an AutoGrind 280 from CFS through a 40 mm holeplate.

The app. 300 kg of meat contains about 210 kg of water. With a wanted remaining crystallization of 25%, 157 kg must be defrosted which will require 12500 kcal or 28 kg of steam. The amount of steam added is 10 kg/min. The net steaming time is thus 28/10=2.8 minutes or 168 seconds.

All meats were loaded into the mixer and the defrosting program started.

| Mixer speed | 12 | rpm |
|---|---|---|
| wings forward | 30 | sec |
| wings reverse | 30 | sec |
| Steam on vacuum | 95% | |
| Steam off vacuum | 90% | |
| Steam pulse | 4 | sec |
| Steam pause | 6 | sec |
| Steam time | 170 | sec |

Total running time including vacuumizing=780 sec.

Temperature after defrosting −1.1 C

After defrosting 4.5 kg of dry salt was added and mixed at 30 rpm for 120 seconds.

After addition of salt the temperature was −1.8 C

Added steam

27 kg

Evaluation: The mixture was homogeneously defrosted, soft and suitable for forming.

### EXAMPLE II

In order to have a more firm mixture, the steaming time was reduced from 170 sec to 120 sec. All other settings were as example I. During the running time, the below values were noted:

| | | Time | Steam | | Vac |
|---|---|---|---|---|---|
| Vacuum % | Weight | sec | sec | Temp | time |
| 0 | 373 | 0 | 0 | −7.5 | |
| 95 | 373 | 150 | 0 | | 150 |
| 90 | 381 | 246 | 36 | | |
| 95 | 381 | 285 | 36 | | 39 |
| 90 | 386 | 385 | 75 | | |
| 95 | 386 | 434 | 75 | | 49 |
| 90 | 389 | 513 | 109 | | |
| 95 | 389 | 550 | 109 | | 37 |
| 90 | 391 | 601 | 120 | −1.6 | 275 |

4.5 kg of salt were added and mixed into the meat at 30 rpm during 120 sec. The temperature after adding the salt was −2.3 C and the mix was perfectly firm and suitable for forming and further processing. Added condensate during defrosting 5 weight % based on the initial weight. The mix was formed to a thick product and cooked through in a continuous cooker for 10 minutes. Cooking loss was around 4 weight-%.

### EXAMPLE III

In this example the 40 mm holeplate, according to Example I and II was replaced by a 3 hole precutter. All other parametres as set in example II

| | | Time | Steam | | Vac |
|---|---|---|---|---|---|
| Vacuum % | Weight | sec | sec | Temp | time |
| 0 | 332 | 0 | 0 | −8 | |
| 95 | 332 | 155 | 0 | | |
| 90 | 341 | 247 | 36 | | |
| 95 | 341 | 292 | 36 | | |
| 90 | 344 | 380 | 74 | | |
| 95 | 345 | 417 | 74 | | |
| 90 | 347 | 464 | 91 | | |
| 95 | 346 | 489 | 91 | | |
| 90 | 352 | 560 | 117 | | |
| 95 | 350 | 594 | 117 | | |
| 0 | 350 | 620 | 120 | −1.5 | |

4.5 kg of salt were added and mixed into the meat at 30 rpm during 120 sec. The temperature after adding the salt was −2.6 C and the mix was perfectly firm and suitable for forming and further processing.

There was clearly more breast fillet structure, but then of course also a very coarse thigh meat structure. Two different grinds are necessary for nuggets, i.e. precutter for breast and 8-13 mm for thigh meat.

1. Process for defrosting of frozen crushed meat in a mixer, characterized by the following steps:
a. crushing the frozen meat,
b. loading the crushed meat into a mixer,
c. mixing the crushed meat,
d. applying at least partial vacuum to the mixer, and
e. adding steam to the mixer,
whereas steps c-e are at least partially in parallel.

2. Process according to claim 1, characterized in, that the frozen meat is cuttered or ground prior to defrosting.

3. Process according to claim 1, characterized in, that the vacuum is established around 20-150 mbar.

4. Process according to claim 1, characterized in, that the steam temperature in the mixer does not exceed 60° C.

5. Process according to claim 1, characterized in, that the steam is applied intermittently.

6. Process according to claim 1, characterized in, that the remaining crystallization of the water in the meat is 20-40, weight-%.

7. Process according to claim 1, characterized in, that the added condensate during defrosting is between 4 and 9 weight-% of the initial weight of the meat.

8. Process according to claim 1, characterized in, that the temperature of the crushed meat does not exceed 0° C. during the defrosting.

9. Process according to claim 1, characterized in, that the spices are added during mixing.

10. Process according to claim 1, characterized in, that the defrosted crushed meat is at least one of formed, deboned or further crushed.

11. Mixer comprising a bowl, at least one paddle, and means to apply steam and at least a partial vacuum to the bowl.

12. Mixer according to claim 11, characterized in, that the steam is added to a bottom of the mixer.

13. Mixer according to claim 11 being configured for defrosting of ground meat and/or carcasses in the presence of vacuum and steam.

14. Process according to claim 1, characterized in, that the steam temperature in the mixer does not exceed 50° C.

15. Process according to claim 1, characterized in, that the steam temperature in the mixer does not exceed 40° C.

16. Process according to claim 1, characterized in, that the remaining crystallization of the water in the meat is 20-30 weight-%.

17. Process according to claim 1, characterized in, that the added condensate during defrosting is between 5 and 8 weight-% of the initial weight of the meat.

18. Process according to claim 1, characterized in, that the temperature of the crushed meat does not exceed −1° C. during the defrosting.
